(19) United States
(12) Patent Application Publication
(10) Pub. No.: US 2025/0038383 A1
(43) Pub. Date: Jan. 30, 2025

(54) ELECTROLYTE INJECTION DEVICE AND MANUFACTURING METHOD FOR SECONDARY BATTERY USING SAME

(71) Applicant: SK ON CO., LTD., Seoul (KR)

(72) Inventors: Taek Eon JEONG, Daejeon (KR); Dong Ju KIM, Daejeon (KR); Sun Min PARK, Daejeon (KR); Jae Gyu BYUN, Daejeon (KR)

(21) Appl. No.: 18/784,686

(22) Filed: Jul. 25, 2024

(30) Foreign Application Priority Data
Jul. 27, 2023 (KR) 10-2023-0098506

(51) Int. Cl. H01M 50/636; H01M 10/04

(52) U.S. Cl. CPC H01M 50/636; H01M 10/049

(57) ABSTRACT

Methods of manufacturing secondary batteries are disclosed. In an embodiment, a method may include: placing an exterior material including an exterior material bending part, a main room, and a gas room spaced apart from the main room; inserting an electrode assembly into the main room; sealing opposite open ends of the exterior material; forming a support sealing part in a space between the gas room and the main room to divide the space into at least two spaces in a longitudinal direction; injecting an electrolyte into the at least two spaces; sealing a second end of the exterior material; forming at least one discharge hole on a side of the gas room; cutting the exterior material including the support sealing part and the gas room above the main room after internal gas is discharged; and sealing the second end of the cut exterior material above the main room.

### CROSS REFERENCE TO RELATED APPLICATION

This patent document claims the priority and benefits of Korean Patent Application No. 10-2023-0098506, filed Jul. 27, 2023, the entire contents of which is incorporated herein by reference for all purposes.

### TECHNICAL FIELD

The technology and implementations disclosed in this patent document generally relate to an electrolyte injection device and a manufacturing method for a secondary battery using the same.

### BACKGROUND

Recently, secondary batteries have been attracting attention as a prominent energy source and are widely used in IT products, automobiles, and energy storage systems. In the field of IT products, secondary batteries are required to support long continuous usage, as well as miniaturization and weight reduction. In the automotive sector, secondary batteries are required to meet demands for high power, durability, and stability to mitigate explosion risks. In the energy storage sector, secondary batteries are used for storing surplus power produced from wind and solar energy, etc. Given their stationary application in the energy storage sector, they can be subjected to more relaxed conditions.

### SUMMARY

The disclosed technology can be implemented in some embodiments to provide an electrolyte injection device and a manufacturing method for a secondary battery using the same, thereby reducing or minimizing manufacturing defects such as deformation of a secondary battery caused by increased internal electrolyte due to increase in size and thickness of a high-capacity pouch-type battery.

In an embodiment of the disclosed technology, a manufacturing method for a secondary battery may include placing an exterior material including: an exterior material bending part on a first end thereof; a main room; and a gas room spaced apart from the main room in a direction from the exterior material bending part to a second end thereof; inserting an electrode assembly into the main room; sealing open ends of the exterior material extending from sides of the exterior material bending part; forming a support sealing part in a space between the gas room and the main room to divide the space into at least two spaces in a longitudinal direction of the main room; injecting an electrolyte into each of the at least two spaces; scaling the second end of the exterior material; forming at least one discharge hole on a side of the gas room; cutting the exterior material including the support sealing part and the gas room above the main room after internal gas is discharged through the discharge hole of the gas room; and sealing the second end of the cut exterior material above the main room.

In an embodiment of the disclosed technology, the exterior material is formed by molding the main room and the gas room to form separate spaces inside the exterior material.

In some implementations, the support sealing part extends in a direction perpendicular to the longitudinal direction of the main room. The forming of the support sealing part includes dividing the space into the at least two spaces in the longitudinal direction of the main room.

In some implementations, the forming of the support sealing part provided in the space between the gas room and the main room to divide the space into at least two spaces in the longitudinal direction of the main room may further include: forming the support sealing part to extend by a predetermined length in a direction parallel to the longitudinal direction of the main room, and to divide the space into the at least two spaces in the longitudinal direction of the main room.

In some implementations, the support sealing part has a circular shape with a predetermined diameter in the space. The forming of the support sealing part includes dividing the space into the at least two spaces in the longitudinal direction of the main room.

In some implementations, the forming of the support sealing part may include: forming at least one support sealing part extending by a predetermined length in a direction parallel to the longitudinal direction of the main room, and/or forming at least one support sealing parts extending in a direction perpendicular to the longitudinal direction of the main room.

In some implementations, the injecting of the electrolyte into each of the at least two spaces may further include: injecting the electrolyte into the main room using an electrolyte injection device that includes a plurality of individual nozzles by injecting the electrolyte into the at least two spaces in the longitudinal direction of the main room.

In some implementations, the injecting of the electrolyte into each of the at least two spaces may further include: measuring weight of each location of the exterior material where the electrolyte is injected using weight sensors attached to a bottom of the exterior material and adjusting, based on the measured weight of each location of the exterior material, an amount of electrolyte injected through the individual nozzles.

In an embodiment of the disclosed technology, an electrolyte injection device, in which an electrode assembly is accommodated inside an exterior material and a plurality of electrolyte injection ports are provided at a first end of the exterior material, includes: a plurality of individual nozzles configured to inject an electrolyte into each of injection ports and including control valves for controlling an amount of the electrolyte injected into each of the injection ports; a supply hopper including a supply control valve to supply the electrolyte to the individual nozzles; a plurality of weight sensors spaced apart from each other in a longitudinal direction and disposed at a second end of an exterior material opposite the electrolyte injection ports; a weight measurement part configured to measure weight values for each location of the weight sensors; and a supply control part configured to, based on the measure weight values for each location of the weight sensors, individually control an electrolyte supply amount for each location of the individual nozzles, and control a total injection amount of the electrolyte supplied from the supply hopper.

In some implementations, the weight measurement part may include: a first weight sensor and a second weight sensor disposed on opposite sides of a bottom of the exterior material; and a third weight sensor disposed in a center of the bottom of the exterior material.

In some implementations, the device may further include: a distribution pipe provided to distribute the electrolyte supplied from the supply hopper to the individual nozzles.

The features and advantages of the disclosed technology will become more apparent from the following detailed description based on the accompanying drawings.

In some embodiments of the disclosed technology, electrolyte injection devices and secondary batteries can be implemented to effectively prevent sagging of secondary battery exterior materials due to electrolyte injection imbalance when manufacturing secondary batteries.

In some implementations, production lead time can be improved by more efficiently improving the secondary battery manufacturing process by forming an exterior material bending part of an exterior material during secondary battery manufacturing.

In some implementations, during secondary battery manufacturing, the efficiency of electrolyte injection can be improved by effectively dividing and partitioning an injection space when injecting electrolyte, and partial contraction or relaxation of an exterior material due to electrolyte injection location or electrolyte injection amount can be effectively prevented.

In some implementations, by effectively preventing physical deformation of an exterior material during secondary battery manufacturing, the possibility that the deformation of the exterior material is transferred to a separator and reduces a charge/discharge area of a battery can be minimized, thereby effectively improving and maintaining the lifespan and performance of the secondary battery.

In some implementations, by preventing physical deformation of an exterior material during secondary battery manufacturing, the electrical performance of a secondary battery can be maintained and the generation of lithium salt in an uncharged area due to physical deformation of an exterior material can be prevented.

In some implementations, by improving the reliability of secondary battery manufacturing, the yield of secondary battery manufacturing can be improved, and the electrical performance and lifespan of a manufactured secondary battery can be stably maintained.

In some implementations, due to an electrolyte injection device for a secondary battery exterior material, the weight of each location of an exterior material when injecting electrolyte inside the exterior material can be measured to minimize the locational deviation of electrolyte filling, so that the reliability of electrolyte injection for secondary batteries of various shapes and sizes can be increased, and the reliability and efficiency of manufacturing large-capacity secondary batteries can be further improved.

### BRIEF DESCRIPTION OF THE DRAWINGS

FIG. 1 is a schematic view illustrating an operation of preparing an exterior material when performing a manufacturing method for a secondary battery based on some embodiments of the disclosed technology.

FIG. 2 is a schematic view illustrating an operation of inserting an electrode assembly into an exterior material when performing a manufacturing method for a secondary battery based on some embodiments of the disclosed technology.

FIG. 3 is a schematic view illustrating an operation of sealing opposite ends of an exterior material when performing a manufacturing method for a secondary battery based on some embodiments of the disclosed technology.

FIG. 4 is a schematic view illustrating an operation of forming a support sealing part on an exterior material when performing a manufacturing method for a secondary battery based on some embodiments of the disclosed technology.

FIGS. 5 and 6 are schematic views illustrating an operation of injecting electrolyte into an exterior material when performing a manufacturing method for a secondary battery based on some embodiments of the disclosed technology.

FIG. 7 is a schematic view illustrating an operation of sealing the other end of an exterior material when performing a manufacturing method for a secondary battery based on some embodiments of the disclosed technology.

FIG. 8 is a schematic view illustrating discharging gas from a gas room to the outside based on some embodiments of the disclosed technology.

FIG. 9 is a schematic view illustrating an operation of removing an exterior material including a gas room when performing a manufacturing method for a secondary battery based on some embodiments of the disclosed technology.

FIGS. 10 and 11 are schematic views illustrating an example of a support sealing part based on some embodiments of the disclosed technology.

FIGS. 12 to 14 are schematic views illustrating another example of a support sealing part based on some embodiments of the disclosed technology.

FIGS. 15 to 17 are schematic views illustrating another example of a support sealing part based on some embodiments of the disclosed technology.

FIG. 18 is a schematic view illustrating an operation of an electrolyte injection device based on an embodiment of the disclosed technology.

### DETAILED DESCRIPTION

The demand for high-capacity secondary batteries with higher energy densities is growing. These high-capacity batteries are larger and thicker than traditional batteries, and as the internal electrolyte volume increases, various electrical and physical issues may arise due to the physical deformation of the exterior material and the increase in the physical size of the battery during the manufacturing process. As a result, there is a growing technical need for more stable and reliable manufacturing methods for secondary batteries.

The disclosed technology can be implemented in some embodiments to address these issues. Hereinafter, some embodiments of the disclosed technology will be described in detail with reference to the attached drawings.

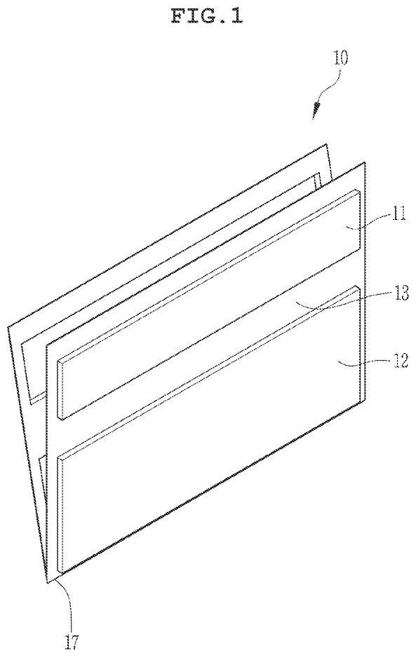

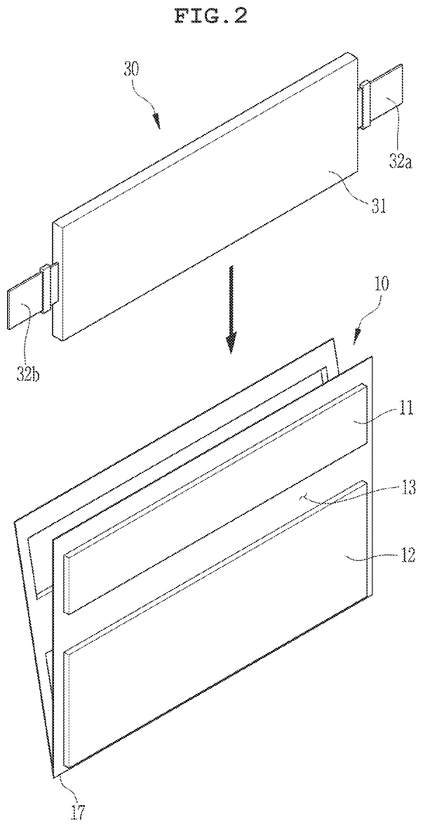

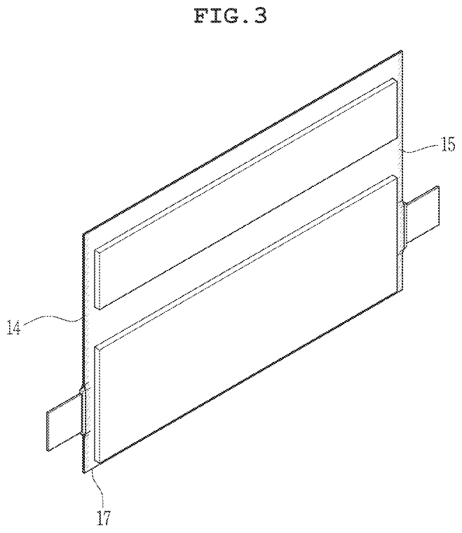

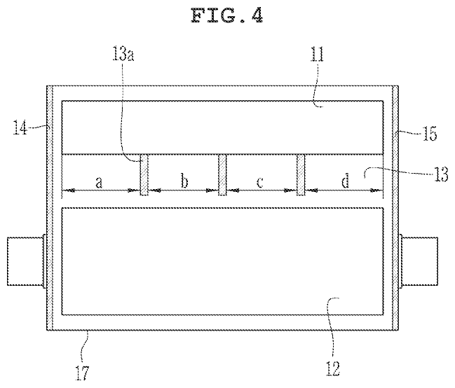

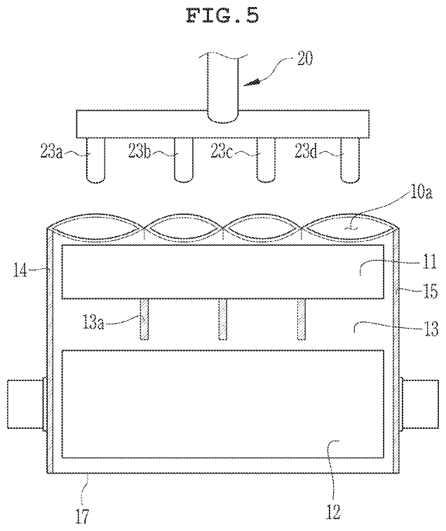

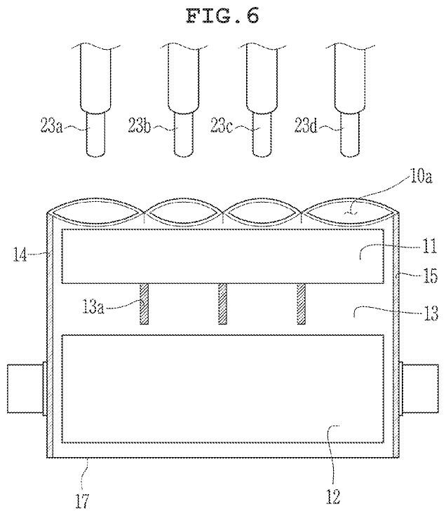

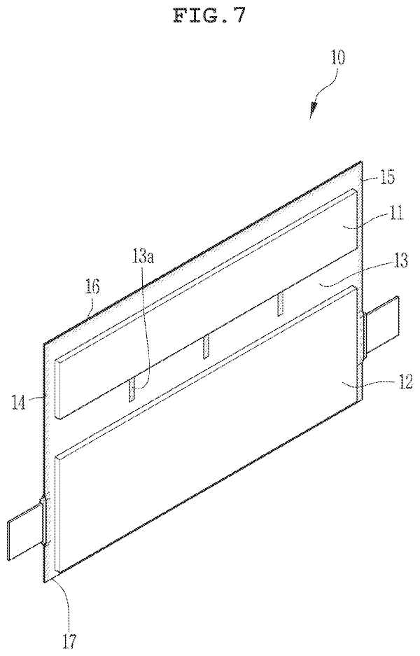

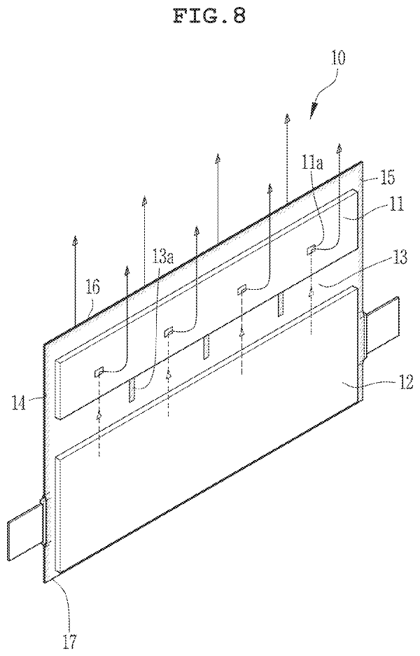

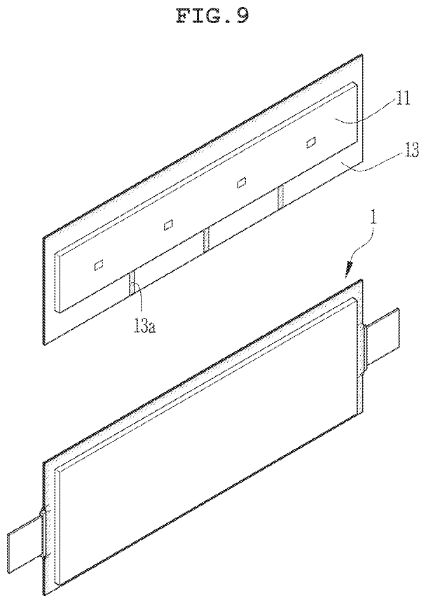

FIG. 1 is a schematic view illustrating an operation of an exterior material as an electrode assembly holding device that is used to receive an electrode assembly when performing a manufacturing method for a secondary battery based on some embodiments of the disclosed technology. FIG. 2 is a schematic view illustrating an operation of inserting an electrode assembly into an exterior material when performing a manufacturing method for a secondary battery based on some embodiments of the disclosed technology. FIG. 3 is a schematic view illustrating an operation of sealing opposite ends of an exterior material when performing a manufacturing method for a secondary battery based on some embodiments of the disclosed technology. FIG. 4 is a schematic view illustrating an operation of forming a support sealing part on an exterior material when performing a manufacturing method for a secondary battery based on some embodiments of the disclosed technology. FIGS. 5 and 6 are schematic views illustrating an operation of injecting electrolyte into an exterior material when performing a manufacturing method for a secondary battery based on some embodiments of the disclosed technology. FIG. 7 is a schematic view illustrating an operation of sealing the other end of an exterior material when performing a manufacturing method for a secondary battery based on some embodiments of the disclosed technology. FIG. 8 is a schematic view illustrating discharging gas from a gas room to the outside based on some embodiments of the disclosed technology. FIG. 9 is a schematic view illustrating an operation of removing an exterior material including a gas room when performing a manufacturing method for a secondary battery based on some embodiments of the disclosed technology.

In an embodiment, a manufacturing method for a secondary battery of the disclosed technology includes: preparing an exterior material or the electrode assembly holding device 10 having an exterior material bending part 17 on one end thereof, and having a main room 12 and a gas room 11 spaced apart from the main room 12 in the direction from the exterior material bending part 17 to the other end thereof; inserting an electrode assembly 30 into the main room 12; sealing opposite open ends of the exterior material or electrode assembly holding device 10 extending from opposite sides of the exterior material bending part 17; forming a support sealing part 13a formed in a space between the gas room 11 and the main room 12 to divide the space into at least two spaces in the longitudinal direction of the main room 12; injecting an electrolyte into each of the two or more spaces; sealing the other end of the exterior material or electrode assembly holding device 10; forming at least one discharge hole 11a on one side of the gas room 11; cutting the exterior material of the electrode assembly holding device 10 including the support scaling part 13a and the gas room 11 above the main room 12 after internal gas is discharged through the discharge hole 11a of the gas room 11; and sealing the other end of the cut exterior material portion of the electrode assembly holding device 10 above the main room 12.

As shown in FIG. 1, the manufacturing method for a secondary battery of the disclosed technology first involves the operation of preparing the exterior material of the electrode assembly holding device 10.

As shown, the exterior material for the electrode assembly holding device 10 may have the exterior material bending part 17 formed so that one end of the exterior material 10 is folded. The bent exterior material of the electrode assembly holding device 10 may include the functional areas of the main room 12 in which the electrode assembly 30 is accommodated, and the gas room 11 provided above the main room 12 accommodating the electrode assembly 30 and where internal gas may be discharged. By forming the exterior material bending part 17, the efficiency of the process flow of secondary battery manufacturing may be increased, and by forming the support sealing part 13a between the gas room 11 and the main room 12 together with the exterior material bending part 17, processability and durability of a secondary battery may be effectively secured.

In an embodiment of the disclosed technology, the areas of the main room 12 and the gas room 11 of the exterior material of the electrode assembly holding device 10 may be molded to create physical spaces. That is, as shown in FIG. 1, the main room 12 is formed at the lower part of the exterior material of the electrode assembly holding device 10 to create a separate space therein to accommodate the electrode assembly 30 while the gas room 11 that is spaced apart from the main room to create a physical space is formed above the main room 12 so that the internal gas may be collected and discharged.

The main room 12 and the gas room 11 are functional areas dividing the internal space of the exterior material 10 into separate spaces to make the location of the electrode assembly 30 more clear and to induce smooth discharge during the degassing through collection of internal gas, effectively securing the reliability and precision of the secondary battery manufacturing process.

As shown in FIG. 2, an operation of accommodating the electrode assembly 30 in the main room 12 of the electrode assembly holding device 10 is performed. Although FIG. 2 shows the electrode assembly with tab parts 32a and 32b formed at opposite ends thereof, the shape of the electrode assembly 30, that is, the configuration or arrangement of the tab parts 32a and 32b, is not particularly limited. In some implementations, the tab parts 32a and 32b are formed with a positive electrode tab at one end of a main body 31 of the electrode assembly 30 and a negative electrode tab at the other end of the main body 31 of the electrode assembly 30, forming tabs of mutually opposite polarity. The arrangement and order of the positive and negative tabs may be appropriately changed depending on the type of secondary battery.

When the electrode assembly 30 is accommodated in the main room 12 of the exterior material 10, it is preferable that the tab parts 32a and 32b at opposite ends of the electrode assembly 30 are accommodated so as to be exposed to the outside of the exterior material of the electrode assembly holding device 10 for electrical connection.

As shown in FIG. 3, as the tab parts 32a and 32b at opposite ends of the electrode assembly 30 accommodated in the main room 12 are exposed to the outside, the interior of the exterior material of the electrode assembly holding device 10 may be sealed by sealing opposite ends of the exterior material 10. A first scaling part 14 and a second scaling part 15 may be formed by sealing opposite ends of the exterior material of the electrode assembly holding device 10 extending from the exterior material bending part 17 at the bottom of the exterior material of the electrode assembly holding device 10.

As shown in FIG. 4, the support sealing part 13a is formed on the area between the main room 12 and the gas room 11 of the electrode assembly holding device 10.

The support sealing part 13a is used to effectively maintain a uniform distribution of the electrolyte injection amount during the process of injecting an electrolyte into the main room 12 of the electrode assembly holding device 10 in order to prevent the exterior material 10 from sagging in a specific direction.

The support sealing part 13a is used to divide a location (area) of an injection part where the electrolyte is injected into the main room 12 of the exterior material 10 into two or more spaces to even out the electrolyte flow inside the exterior material 10 when the electrolyte is injected. In addition, the support scaling part 13a prevent the exterior material 10 from sagging by maintaining the physical fixation and support force of the exterior material on a support area 13 between the main room 12 and the gas room 11.

In an embodiment, as shown in FIG. 4, at least two support scaling parts 13a may be provided to extend in the direction of electrolyte injection. In FIG. 4, three support sealing parts 13a may be provided to maintain a certain distance in the space between the main room 12 and the gas room 11 of the exterior material 10. When three support sealing parts 13a are formed, the support sealing parts 13a may be arranged at 1/4, 2/4, and 3/4 points, respectively, of the total length in the longitudinal direction of the main room 12 into which the electrolyte is injected.

By maintaining equal spacing between a to d, which is the spacing between the support sealing parts 13a in FIG. 4, a partitioned space (injection port) 10a for electrolyte injection may be effectively distributed, and the load due to the amount of electrolyte injection may be prevented from being biased on the exterior material 10 at a specific location during electrolyte injection.

In this case, a plurality of support sealing parts 13a may be provided in a direction perpendicular to the longitudinal direction in which the main room 12 is formed. In this way, the support force for the load in the upper and lower directions is effectively maintained due to the plurality of support scaling parts 13a, and the exterior material 10 may be effectively supported at opposite ends of each injection area when the electrolyte is injected.

FIGS. 5 and 6 are schematic views illustrating the injection of an electrolyte into the exterior material 10. The electrolyte injection location (area) is divided into at least two spaces by the support scal parts 13a, and the electrolyte may be injected into each divided injection port 10a. At this time, an electrolyte injection device 20 may include a plurality of individual nozzles 23a, 23b, 23c, and 23d for injecting an electrolyte into the each partitioned space. By effectively controlling the amount or speed of an electrolyte injected from individual nozzles 23a, 23b, 23c, and 23d, when injecting an electrolyte into the exterior material 10, the variation in load for each location of the exterior material 10 may be effectively reduced.

To be specific, the individual nozzles 23a, 23b, 23c, and 23d are connected to a supply hopper 21 for electrolyte supply, and the individual nozzles 23a, 23b, 23c, and 23d are equipped with respective control valves 24a, 24b, 24c, and 24d. Accordingly, the operation of controlling the opening/closing and injection amount of electrolyte injection for the individual nozzles 23a, 23b, 23c, and 23d by a supply control part 25 may be further included.

In addition, the operation of adjusting, by the supply control part 25, the electrolyte supply amount by location of the individual nozzles 23a, 23b, 23c, and 23d may be further included as a plurality of weight sensors 26a, 26b, and 26c are placed at the bottom of the exterior material 10 and weight measurement values measured by the weight sensors 26a, 26b, and 26c for each location of the exterior material 10 are used.

In this case, the number of individual nozzles or the location and number of weight sensors are not limited to the examples in the drawings and may be appropriately changed and adjusted depending on the shape or size of the exterior material.

By doing so, even when manufacturing high-capacity secondary batteries, physical sagging of the exterior material 10 is prevented, and the formation of wrinkles, etc. in the exterior material 10 due to such sagging may be effectively prevented.

In addition, the possibility that the deformation of the exterior material 10 is transferred to a separator and reduces a charge/discharge area of a battery may be minimized, thereby effectively improving and maintaining the lifespan and performance of the secondary battery. Furthermore, by preventing physical deformation of the exterior material 10, the electrical performance of a secondary battery may be maintained and the generation of lithium salt in an uncharged area due to physical deformation of the exterior material 10 may be prevented.

As shown in FIG. 7, the operation of sealing the other side end at the upper part of the exterior material 10, in which the electrolyte injection is completed, is performed. By sealing the other side end of the exterior material 10 to form a third sealing part 16, the interior of the exterior material 10 may be sealed. As shown in FIG. 8, the operation of forming the discharge hole 11a to discharge the gas collected in the gas room 11 of the exterior material 10 is performed. At least one discharge hole 11a may be formed in the area of the gas room 11, and the formation area, location, and shape of the discharge hole 11a are not particularly limited. The discharge hole 11a is for discharging the internal gas collected in the gas room 11 of the exterior material 10 to the outside after sealing the other side end of the exterior material 10 and testing the charging and discharging of a secondary battery.

As shown in FIG. 9, the operation of removing the area above the main room 12 including the gas room 11 of the exterior material 10 is performed after exhausting all internal gas in the exterior material.

In some implementations, the manufacturing of the secondary battery may be finalized by cutting the remaining area excluding the main room 12 area where the electrode assembly 30 is stored.

In some implementations, the area including the support scaling parts 13a, which are for equalizing load distribution according to electrolyte injection and effectively maintaining the lower support force of the exterior material 10, is removed. In this way, the secondary battery may be finally manufactured.

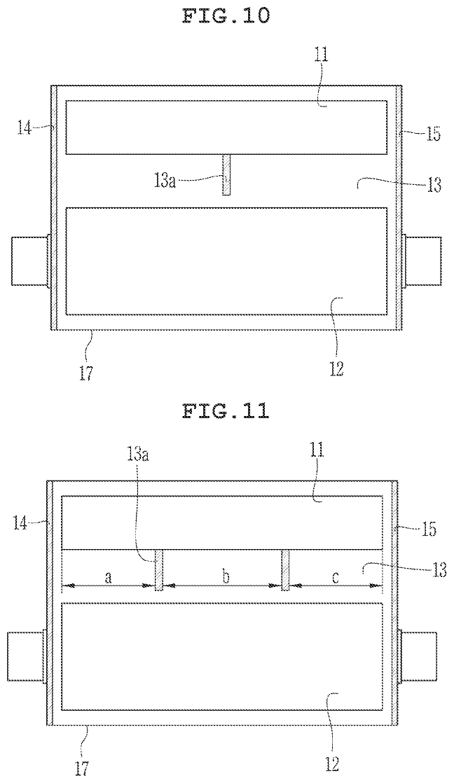

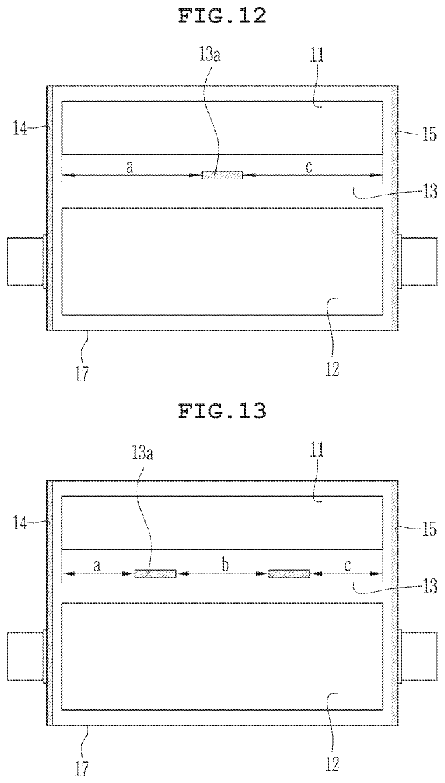

FIGS. 10 and 11 are schematic views illustrating an example of a support sealing part based on some embodiments of the disclosed technology. FIGS. 12 to 14 are schematic views illustrating another example of a support sealing part based on some embodiments of the disclosed technology. FIGS. 15 to 17 are schematic views illustrating another example of a support sealing part based on some embodiments of the disclosed technology.

As shown in FIGS. 10 and 11, the support sealing part 13a may be provided on the area between the main room 12 and the gas room 11, and may be provided perpendicular to the longitudinal direction in which the main room 12 is formed.

As shown in FIG. 10, the support sealing part 13a may be provided as a single support sealing part 13a in the center area, so that the space for electrolyte injection may be separated into two spaces, one side and the other side. In this case, the length of the vertical extension of the support sealing part 13a may be adjusted appropriately. When manufacturing a high-capacity secondary battery, the area between the gas room 11 and the main room 12 may be adjusted to extend the vertical length of the support sealing part to increase the bearing capacity for the vertical load of the exterior material 10.

In some implementations, the support sealing part 13a may be formed in a rectangular shape with the vertical direction as the longitudinal direction. To be specific, in the drawing, the ratio of the horizontal length to the vertical length may be 1:3.

By adjusting the support length for support in the vertical load direction corresponding to the separation distance of the electrolyte injection space as above, the exterior material 10 as a whole may effectively maintain the physical balance according to the electrolyte injection process or injection amount.

Alternatively, two support scaling parts 13a may by formed at regular intervals in the longitudinal direction of the main room 12 as shown in FIG. 11. Each spacing length may be equalized as a, b, and c, but may be adjusted appropriately considering the shape of a secondary battery and the load bearing capacity according to the specifications of the exterior material 10.

FIGS. 12 to 14 are views showing the shape of a support sealing part 13a according to another embodiment of the disclosed technology.

As shown, at least one support sealing part 13a may be provided parallel to the longitudinal direction in which the main room 12 of the exterior material 10 is formed.

The support sealing part 13a of this embodiment is provided in the longitudinal direction of the main room 12, that is, in the horizontal direction in the drawing, so as to distribute the support force in a predetermined longitudinal direction at the interval of the electrolyte injection space, thereby effectively preventing sagging of the exterior material 10 in a specific direction.

In some implementations, the support sealing part 13a may be formed in a rectangular shape, and specifically, the ratio of the horizontal length to the vertical length may be 3:1. By doing so, the balance of load bearing capacity in the vertical direction compared to the separation distance in the longitudinal direction may be maintained, thereby effectively preventing overall deformation of the exterior material 10 when the electrolyte is injected.

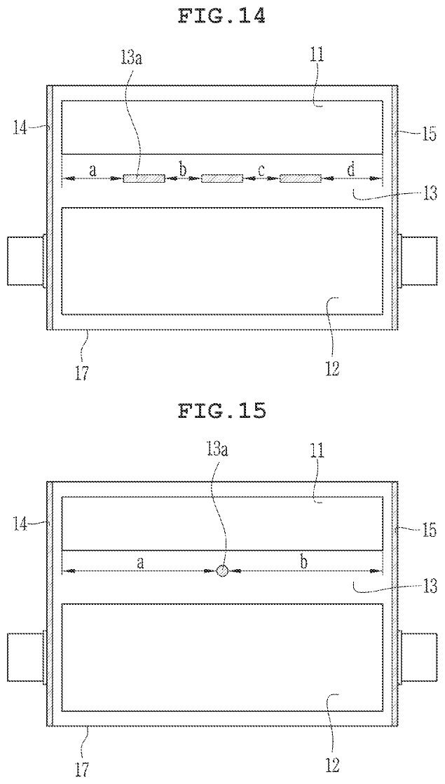

The support sealing part 13a may be placed in the longitudinal center of the main room 12 as shown in FIG. 12, or two or three support sealing parts 13a may be provided at predetermined intervals as shown in FIGS. 13 and 14.

When a plurality of support sealing parts 13a of this embodiment are formed, they may be arranged at regular intervals, but the horizontal lengths of the support sealing parts 13a may vary depending on the specifications of the exterior material 10 or the division of the electrolyte injection space. Alternatively, each interval between the support sealing parts 13a may be appropriately adjusted depending on the capacity or location of electrolyte injection.

FIGS. 15 to 17 are views showing the shape of the support sealing part 13a according to another embodiment of the disclosed technology.

The support sealing part 13a of this embodiment may be formed in a circular shape. At least one circular support sealing part 13a may be provided at a predetermined distance in the longitudinal direction of the area between the main room 12 and the gas room 11 of the exterior material 10. The support sealing part 13a of this embodiment may be provided to have a circular center on a line extending from the middle region of the area between the main room 12 and the gas room 11 of the exterior material 10.

The circular shape of the support sealing part 13a may be formed to have a diameter of 8 to 12 mm when the length of the main room 12 in the longitudinal direction is 300 to 1000 mm.

The range of the circular diameter is to distribute the influence of the spacing of the electrolyte injection part, the electrolyte injection process, and the load in the vertical direction on the exterior material between the main room 12 and the gas room 11 as much as possible. The circular support scaling part 13a maintains a radial support force at a predetermined diameter radius at the point where the support sealing part 13a is formed, and thus, the load on the exterior material 10 during the electrolyte injection process may be distributed in the radial direction.

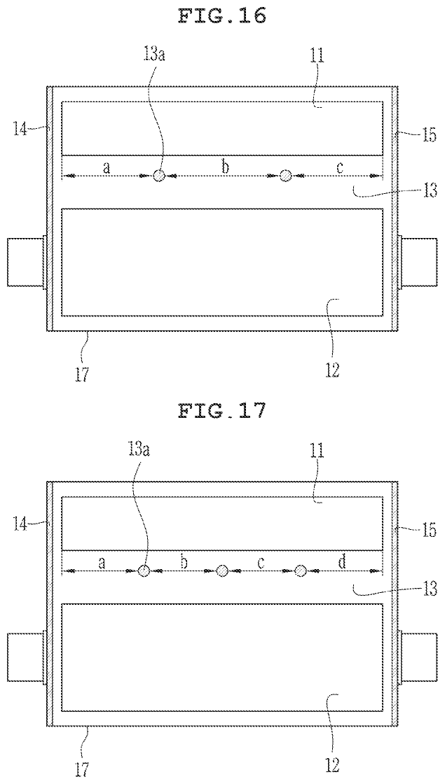

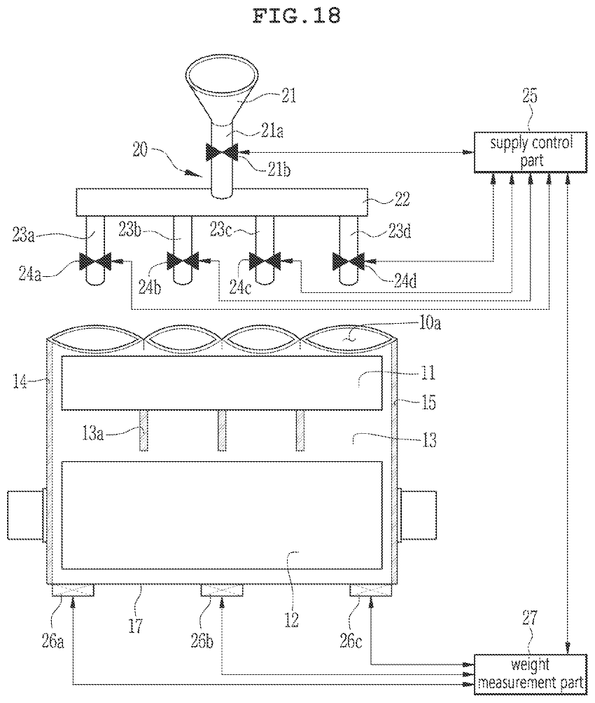

At least one circular support sealing part 13a may be provided as shown in FIG. 15, or two or more circular support scaling parts 13a may be disposed at predetermined intervals as shown in FIGS. 16 and 17. In this case, the arrangement interval of the support sealing parts 13a or whether individual support sealing parts 13a are provided in a circular shape with the same diameter or different diameters when a plurality of support scaling parts 13a are provided may be appropriately designed depending on the influence of the physical load on the exterior material 10 due to the specifications of the exterior material 10 or the amount of electrolyte injected.

FIG. 18 is a schematic view illustrating an operation of an electrolyte injection device based on an embodiment of the disclosed technology.

The electrolyte injection device, in which an electrode assembly 30 is accommodated inside an exterior material 10 and a plurality of electrolyte injection ports 10a are provided at one end of the exterior material 10, according to an embodiment of the disclosed technology may include: a plurality of individual nozzles 23a, 23b, 23c, and 23d provided to inject an electrolyte into each of the injection ports 10a and equipped with respective control valves 24a, 24b, 24c, and 24d for controlling the amount of the electrolyte injected into the each port 10a; a supply hopper 21 provided with a supply control valve 21b to supply the electrolyte to the individual nozzles 23a, 23b, 23c, and 23d; a plurality of weight sensors 26a, 26b, and 26c provided to be spaced apart in the longitudinal direction at the other end of the exterior material 10 opposite the electrolyte injection ports 10a; a weight measurement part 27 that measures weight values by location of the weight sensors; and a supply control part 25 that individually controls the electrolyte supply amount by location of the individual nozzles 23a, 23b, 23c, and 23d according to the weight values by location measured by the weight measurement part 27, and controls the total injection amount of the electrolyte supplied from the supply hopper 21.

As shown in FIG. 18, the electrolyte injection device according to an embodiment of the disclosed technology is designed to accommodate the electrode assembly 30 inside the exterior material 10 and inject an electrolyte.

First, the supply hopper 21 for supplying an electrolyte supplies the electrolyte, and the supplied electrolyte is injected into the exterior material 10 through the plurality of individual nozzles 23a, 23b, 23c, and 23d, that is, a first individual nozzle 23a, a second individual nozzle 23b, a third individual nozzle 23c, and a fourth individual nozzle 23d and through the electrolyte injection ports 10a. A separate distribution pipe 22 may be connected between the supply hopper 21 and the individual nozzles to properly distribute the electrolyte from the supply hopper 21 to the plurality of individual nozzles. The distribution pipe 22 is not limited to a specific structure or method of operation, but it may be appropriate to keep the distribution pipe 22 filled with electrolyte in order to inject the electrolyte into each individual nozzle in real time.

As already described, at one end of the exterior material 10, a plurality of divided electrolyte injection ports 10a are provided so that individual nozzles of the electrolyte injection device may be respectively inserted.

The supply hopper 21 may include a supply pipe 21a through which the electrolyte is injected, and the supply control valve 21b that opens and closes the supply pipe. The device may include the control valves 24a, 24b, 24c, and 24d respectively installed on the individual nozzles 23a, 23b, 23c, and 23d in order to measure and control the injection amount of electrolyte supplied from the supply hopper 21 and to adjust the injection amount of electrolyte for each of the first to fourth individual nozzles 23a, 23b, 23c, and 23d.

Opening and closing and adjustment of the injection amount of the supply control valve 21b of the supply hopper 21 and the first control valve 24a, the second control valve 24a, the third control valve 24a, and the fourth control valve 24a respectively installed in the first individual nozzle 23a, the second individual nozzle 23b, the third individual nozzle 23c, and the fourth individual nozzle 23d may be performed by the supply control part 25.

In addition, at the other end of the exterior material 10 opposite the electrolyte injection ports 10a, the weight sensors 26a, 26b, and 26c may be disposed to measure the weight by location of the exterior material 10 in real time according to the amount of electrolyte injection when electrolyte is injected into the exterior material 10.

In some implementations, a first weight sensor 26a and a second weight sensor 26c may be disposed at opposite ends of the bottom of the exterior material 10, and a third weight sensor 26b may be disposed at the center of the exterior material 10.

The number, arrangement order, and location of weight sensors may vary depending on the shape and size of the exterior material 10.

The disclosed technology can be implemented for manufacturing rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to manufacture improved electrochemical devices such as a battery used in various power sources and power supplies, thereby mitigating climate changes in connection with uses of power sources and power supplies. The secondary batteries made by using the disclosed technology can be used to address various adverse effects such as air pollution and greenhouse emissions by powering electric vehicles (EVs) as alternatives to vehicles using fossil fuel-based engines and by providing battery-based energy storage systems (ESSs). Such secondary batteries may include, for example, lithium ion batteries, nickel-cadmium batteries, nickel-metal hydride batteries, and nickel-hydrogen batteries.

Only specific examples of implementations of certain embodiments are described. Variations, improvements and enhancements of the disclosed embodiments and other embodiments may be made based on the disclosure of this patent document.

What is claimed is:

1. A method of manufacturing a secondary battery, the method comprising:
providing an electrode assembly holding device that includes an exterior material including an exterior material bending part on a first end of the exterior material; a main room; and a gas room spaced apart from the main room in a direction from the exterior material bending part to a second end of the exterior material;
inserting an electrode assembly into the main room of the electrode assembly holding device;
sealing open ends of the exterior material extending from sides of the exterior material bending part;
forming a support sealing part in a space between the gas room and the main room to divide the space into at least two spaces in a longitudinal direction of the main room;
injecting an electrolyte into each of the at least two spaces;
sealing the second end of the exterior material;
forming at least one discharge hole on a side of the gas room;
cutting the exterior material including the support sealing part and the gas room above the main room after internal gas is discharged through the discharge hole of the gas room; and
sealing the second end of the cut exterior material above the main room.

2. The method of claim 1, wherein the exterior material is formed by molding the main room and the gas room to form separate spaces inside the electrode assembly holding device.

3. The method of claim 1, wherein
the support sealing part extends in a direction perpendicular to the longitudinal direction of the main room, wherein the forming of the support sealing part includes dividing the space into the at least two spaces in the longitudinal direction of the main room.

4. The method of claim 1, wherein the support sealing part extends by a predetermined length in a direction parallel to the longitudinal direction of the main room, wherein the forming of the support sealing part includes dividing the space into the at least two spaces in the longitudinal direction of the main room.

5. The method of claim 1, wherein the support sealing part has a circular shape with a predetermined diameter in the space, wherein the forming of the support sealing part includes dividing the space into the at least two spaces in the longitudinal direction of the main room.

6. The method of claim 1, wherein the forming of the support sealing part includes:
forming at least one support sealing part extending by a predetermined length in a direction parallel to the longitudinal direction of the main room; or forming at least one support sealing part extending in a direction perpendicular to the longitudinal direction of the main room.

7. The method of claim 1, wherein the injecting of the electrolyte into each of the at least two spaces includes:
injecting the electrolyte into the main room using an electrolyte injection device that includes a plurality of individual nozzles by injecting the electrolyte into the at least two spaces in the longitudinal direction of the main room.

8. The method of claim 7, wherein the injecting of the electrolyte into each of the at least two spaces includes:
measuring weight of each location of the exterior material where the electrolyte is injected using weight sensors attached to a bottom of the electrode assembly holding device; and adjusting, based on the measured weight of each location of the electrode assembly holding device, an amount of electrolyte injected through the individual nozzles.

9. An electrolyte injection device comprising:
a plurality of individual nozzles configured to inject an electrolyte into each of injection ports and including control valves for controlling an amount of the electrolyte injected into each of the injection ports;
a supply hopper including a supply control valve to supply the electrolyte to the individual nozzles;
a plurality of weight sensors spaced apart from each other in a longitudinal direction and disposed at a second end of an exterior material opposite the electrolyte injection ports;
a weight measurement part configured to measure weight values for each location of the weight sensors; and
a supply control part configured to, based on the measure weight values for each location of the weight sensors, individually control an electrolyte supply amount for each location of the individual nozzles, and control a total injection amount of the electrolyte supplied from the supply hopper.

10. The device of claim 9, wherein the weight measurement part comprises:
a first weight sensor and a second weight sensor disposed on opposite sides of a bottom of the exterior material; and
a third weight sensor disposed in a center of the bottom of the exterior material.

11. The device of claim 9, further comprising:
a distribution pipe provided to distribute the electrolyte supplied from the supply hopper to the individual nozzles.
